(19) United States
(12) Patent Application Publication
(10) Pub. No.: US 2009/0239500 A1
(43) Pub. Date: Sep. 24, 2009

(54) Maintaining secure communication of a network device

(75) Inventors: Ravi Aripirala, Fremont, CA (US); Dipankar Talukdar, San Jose, CA (US)

Correspondence Address: Tzero Technologies, PO Box 641867, San Jose, CA, 95164-1867, US

(73) Assignee: Tzero Technologies, Inc.

(21) Appl. No.: 12/077,673

(22) Filed: Mar. 20, 2008

(51) Int. Cl. H04M 1/66

(52) U.S. Cl. 455/410

(57) ABSTRACT

Methods of a network device maintaining secure communication are disclosed. One method includes the device obtaining identification numbers of all other devices the device is communicating with. The device computes a hash function, wherein inputs to the hash function include the identification numbers of the other devices and a secure hardware-stored identification number of the device. The device calculates a session key based on a master key, a random number and the computed hash function.

### FIELD OF THE DESCRIBED EMBODIMENTS

The described embodiments relate generally to data communications. More particularly, the described embodiments relate to a method and apparatus for maintaining secure communication of a network device.

### BACKGROUND

Wireless networking connects one or more wireless devices to other computer devices without a direct electrical connection, such as a copper wire or optical cable. Wireless devices communicate data, typically in the form of packets, across a wireless or partially wireless computer network and open a “data” or “communication” channel on the network such that the device can send and receive data packets.

Data being transmitted between wireless devices and remote servers often includes sensitive material and may be subject to malicious attack. For example, a home network can distribute copyright protected information, such as, video and music. A rogue interceptor may be able to receive the protected information and either display, listen or reproduce the protected information.

Furthermore, within the wireless device itself, unauthorized client applications downloaded to the device may maliciously or unintentionally access an application programming interface (“API”) with handset firmware, with the potential for causing damage to the handset and to the network.

It is desirable to have methods of securing data being communicated with a network.

### SUMMARY

An embodiment includes a method of a network device maintaining secure communication. The method includes the device obtaining identification numbers of all other devices the device is communicating with. The device computes a hash function, wherein inputs to the hash function include the identification numbers of the other devices and a secure hardware-stored identification number of the device. The device calculates a session key based on a master key, a random number and the computed hash function. The session key is used for encrypting and decrypting data.

Another embodiment includes a method of securing a wireless network of wireless devices. The method includes each wireless device obtaining identification numbers of all other wireless devices the wireless device is communicating with. Each wireless device computes a hash function, wherein inputs to the hash function include the identification numbers of the other devices and a secure hardware-stored identification number of the device. Each wireless device calculates a session key based on a master key, a random number and the computed hash function.

Another embodiment includes a wireless device. The wireless device includes means for the device obtaining identification numbers of all other devices the device is communicating with, a means for the device computing a hash function, wherein inputs to the hash function comprises the identification numbers of the other devices and a secure hardware-stored identification number of the device. The wireless device further includes, means for the device calculating a session key, wherein calculating the session key comprises a master key, a random number and the computed hash function.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an example of a network of wireless devices, including a rogue wireless device.

FIG. 2 shows an example of a block diagram of the functionality of a network device generating a session key.

FIG. 3 shows an example of a block diagram of a network device.

FIG. 4 shows a flow chart of steps of an example of a method of a network device initiating calculation of a session key.

FIG. 5 shows a flow chart of step of an example of a of a network device maintaining secure communication.

### DETAILED DESCRIPTION

The embodiments described include methods and apparatuses for maintaining secure communications between network devices. The methods and apparatuses include a network device computing a session key that is used for encrypting and decrypting transmission data. The session key is computed by each network device in a way that makes it virtually impossible for a rogue device to compute the session key. That is, the network devices are tamper-proof.

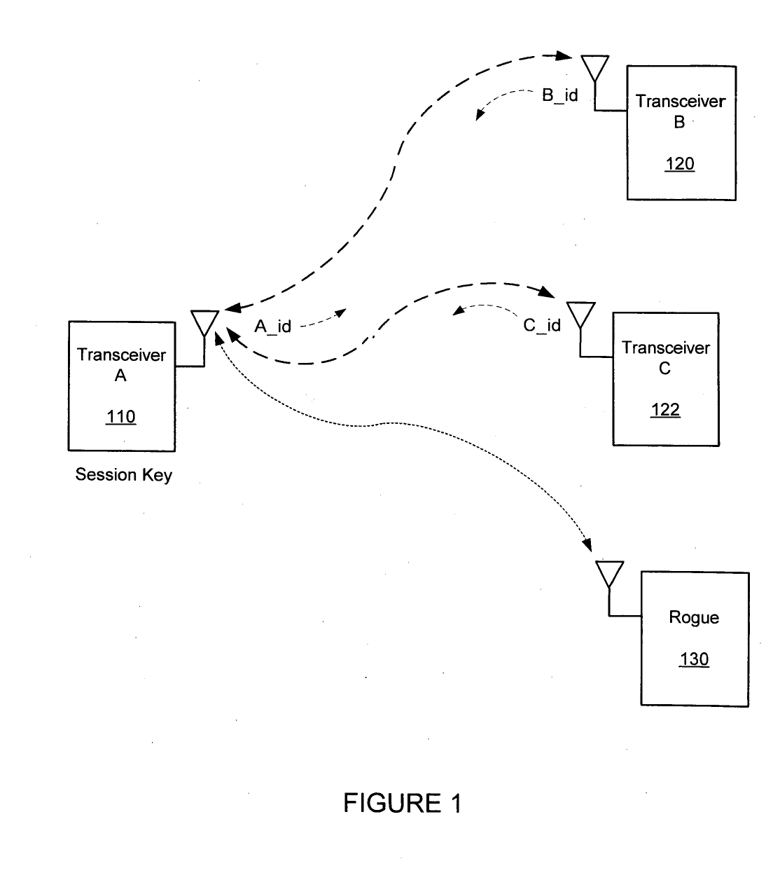

FIG. 1 shows an example of a network of wireless devices, including a rogue wireless device. The wireless network includes a network device A 110, a network device B 112, a network device C 114 and a rogue network device 120. The network devices 110, 112, 114 communicate, for example, home-networking information, such as, video, voice and music.

Each network device 110, 120, 122 must be able to properly compute a session key in order to be able to encrypt and decrypt the information (communication data) that is transmitted between the devices 110, 120, 122 of the wireless network. The session key, however, must be computed in a way that makes it nearly impossible for the rogue device to be able to either properly receive or properly communicate with the devices 110, 120, 122 of the wireless network.

As shown, each of the network devices can include device identification (A_id, B_id, C_id) along with information communicated to the other network devices. Each network device can use the device identification of other devices that the network device has authenticated, along with its own identification (such as, A_id) to generate the session key.

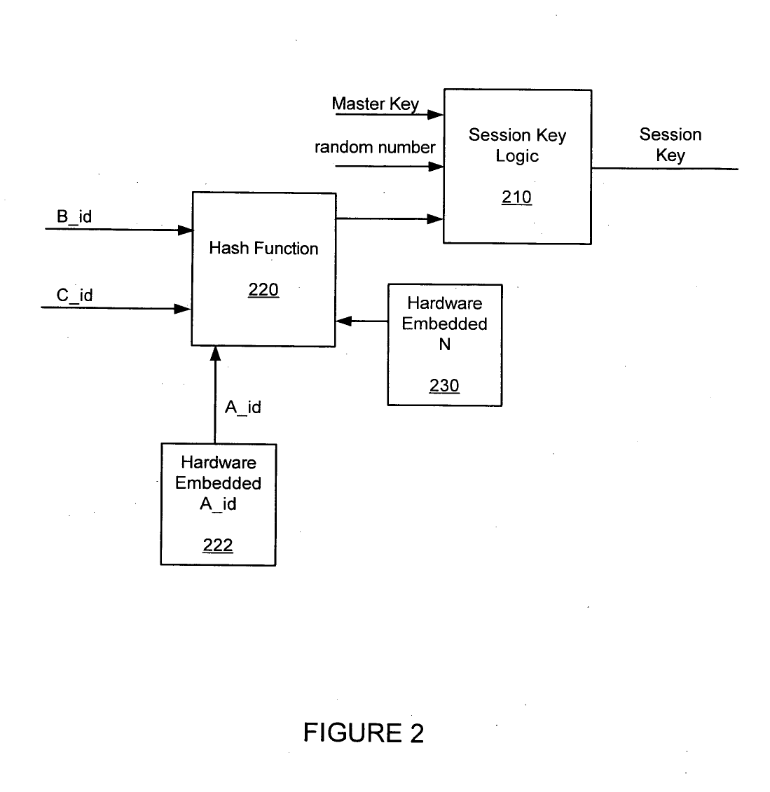

FIG. 2 shows an example of a block diagram of one embodiment of the functionality of a network device that generates a session key. As shown, this embodiment includes the session key logic 210 receiving a master key, a random number, and the output of a hash function 220.

The master key is pre-shared secret that is known by each of the network devices. The random number is a random, arbitrary number that is generated for security purposes and is used one time only. The random number increases the difficulty of breaking security of the network.

As shown, this embodiment includes the hash function 220 receiving identification numbers of all other devices that the network device authenticated. For example, the transceiver 220 provides device identification B_id and the transceiver 222 provides device identification C_id. These device identifications, along with the identification of the device itself, A_id, are input to the hash function 220. Generally, a hash function provides a reproducible method of turning some kind of data into a (relatively) small number that may serve as a digital “fingerprint” of the data. The hash function “chops and mixes” (for example, substitutes or transposes) the data to create such fingerprints.

Hash functions are designed to be fast and to yield few hash collisions in expected input domains. A hash function must be deterministic, that is, if two hashes generated by the same hash function are different, then the two inputs were different in some way. Hash functions are usually not injective, that is, the computed hash value may be the same for different input values. This is because it is usually a requirement that the hash value can be stored in fewer bits than the data being hashed. It is a generally a design goal of hash functions to minimize the likelihood of hash collisions occurring.

It should be observed that the order of the inputs to the hash function influences that output of the hash function. Therefore, an embodiment includes different network devices maintaining consistent ordering of the operands (devices id(s)) input to the hash function of each of the devices. That is, for example, the ordering of the inputs A_id, B_id, C_id, is consistent amongst the hash functions of the device A 110, device B 120, and device C 122, ensuring that the session keys of the devices are consistently computed. This ordering is negotiated by the devices in a pre-determined manner such as an ascending or decending order of the ID's used for the ordering. That is, for example, each network device could use the order A_id, B_id, C_id, or, C_id, B_id, A_id.

For the embodiment of FIG. 2, the device identification (A_id) that is input to the hash function 220 is embedded in hardware 222. The hardware 222 is read-only memory, and is resistant to tampering. That is, it is very difficult for an intruder to modify the device identification (A_id)—unlike firmware stored master keys that are prone to attacks by an intruder. The device identification (A_id) is sent to other devices of the authentication group, and therefore, can typically be detected in firmware, and other network devices. However, the A_id cannot be changed or updated in local computation of the session key. A malicious attacker may be able to change the A_id being transmitted, but the change would result in asymmetric session keys being computed, and therefore, not allow the malicious attacker to successfully decrypt data transmissions.

An embodiment provides another safeguard against attack. More specifically, the number of authenticated devices is controlled by a number N. The number N can be embedded in hardware, such as, shown in FIG. 2. For example, a user of the network devices can purchase a smart card that sets a limit on the number of authenticated devices, and therefore, the number of authenticated device id(s) that are input to the hash function. One embodiment includes N being greater or equal to 2. Another embodiment includes N being greater than 2, which provides more secure communication.

The hardware-stored self-identification of each network device cannot be modified by the devices itself, or by other devices. Various types of hardware implementations can be used for storing the self-identifications of each network device.

One embodiment includes the self-identification of a network device being stored in a field programmable logic array (FPGA) located with the device. One specific embodiment includes the serial number within the FPGA being used as the secure self-identification of the network device that includes the FPGA. Therefore, it is nearly impossible to modify, or externally determine the self-identification of the network devices. An alternate embodiment includes embedding the secure self-identification into configuration information of the FPGA. Another embodiment includes embedding the secure self-identification into hardware logic in which the logic is optimized for obfuscating the self-identification as part of a bit stream of the FPGA.

Another embodiment includes the secure self-identification being burned into a write once-only, read-only EFuse (single time programming) circuit before the device is shipped. Another embodiment includes storing the secure self-identification in an embedded flash circuit with a single time programming EFuse-disabling re-programming, or including a feedback bit to disable reprogramming.

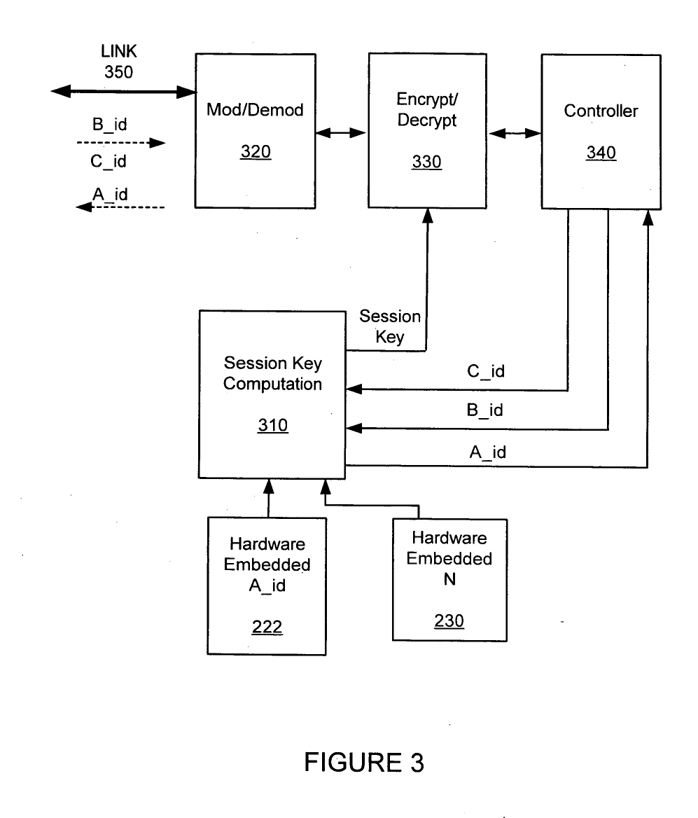

FIG. 3 shows an example of an embodiment of a block diagram of a network device. This embodiment includes the session key computation 310 of FIG. 2 being connected to an encryption/decryption block 330 of the network device.

The network device includes a modulation/demodulation block 320 that aids receiving and transmitting information to other network device through, for example, a link 350. Embodiments of the link 350 include both wired and wireless links. As shown, the device can receive the device identifications from other network devices that have been authenticated by the network device over the link 350.

Generally, authentication of another network device by the network device includes an exchange of the hardware ID's of the device and a hash function computed with the master key. The hardware ID's of associated devices are stored, for example, on an “Embedded smart card” device 230 along with the number N corresponding to the maximum number of authenticated devices. During the authentication stage, the input ID's received over the link are checked against a list of associated device ID's stored on the smart card 230 before a hash is computed.

Communication signals received from the other authenticated network devices are demodulated (by the modulator/demodulator 320), decrypted (by the encrypt/decrypt block 330) and the device identifications (for example, B_id, C_id) are determined by a network device controller 340. The controller 340 can provide the device identifications of the other network devices to the session key computation block 310. As previously described, the other network device identifications (B_id, C_id) along with the device identification (A_id) are input to a hash function within the session key computation 310.

As described, clearly the session key is re-computed as the other network devices that are connected and authenticated changes. That is, all other network devices authenticated by a network device are input to the session key calculations. Therefore, as the authenticated devices change, the session key is recalculated. Other factors can be used to trigger recalculation of the session key as well. For example, duration of time or transmission data of the network device can also be used to trigger recalculation of the session key.

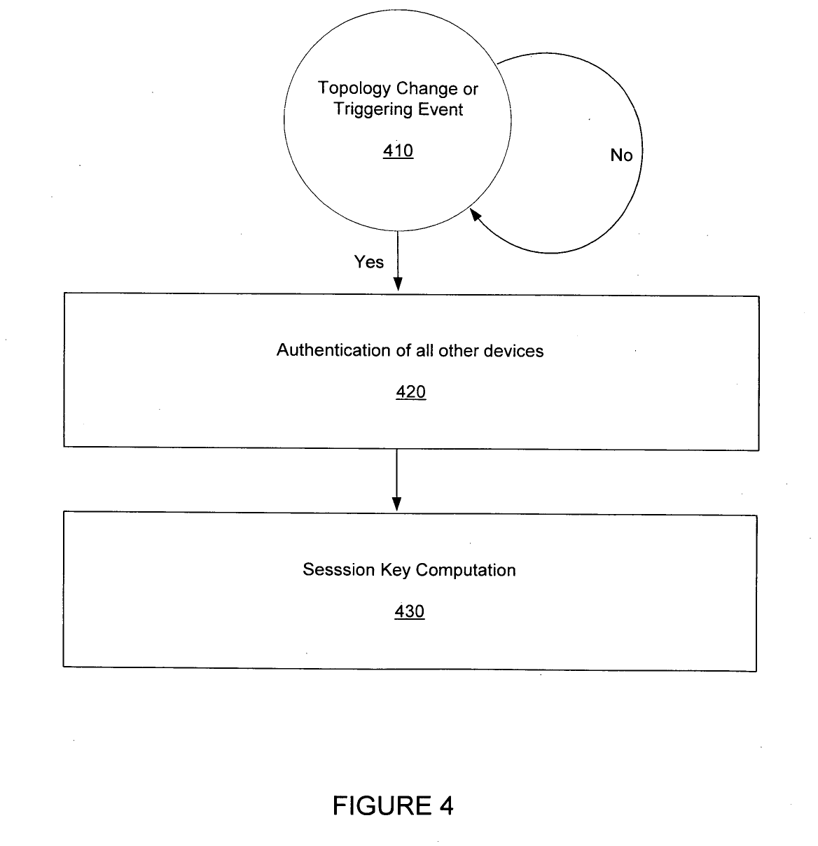

FIG. 4 shows a flow chart of steps of an example of a method of a network device initiating calculation of a session key. A first step 410 includes the device detecting an event that indicates that the session key should be re-calculated. A second step 420 includes the device re-authenticating the other network devices the device is communicating with. A third step 430 includes the device re-computing the session key. After the session key has been computed, the device uses the session key for encrypting and decrypting transmission data.

As previously described, events that can cause re-calculation of a session key include a change is network connection topology (change of authenticated devices). That is, the session key is re-calculated if the authentication group changes.

An embodiment includes the session key being recalculated upon triggering of certain events. Triggers can include duration of time, or the network device having communicated a predetermined amount of information with other network devices.

When the other network devices have been authenticated, the network device computes a new session key.

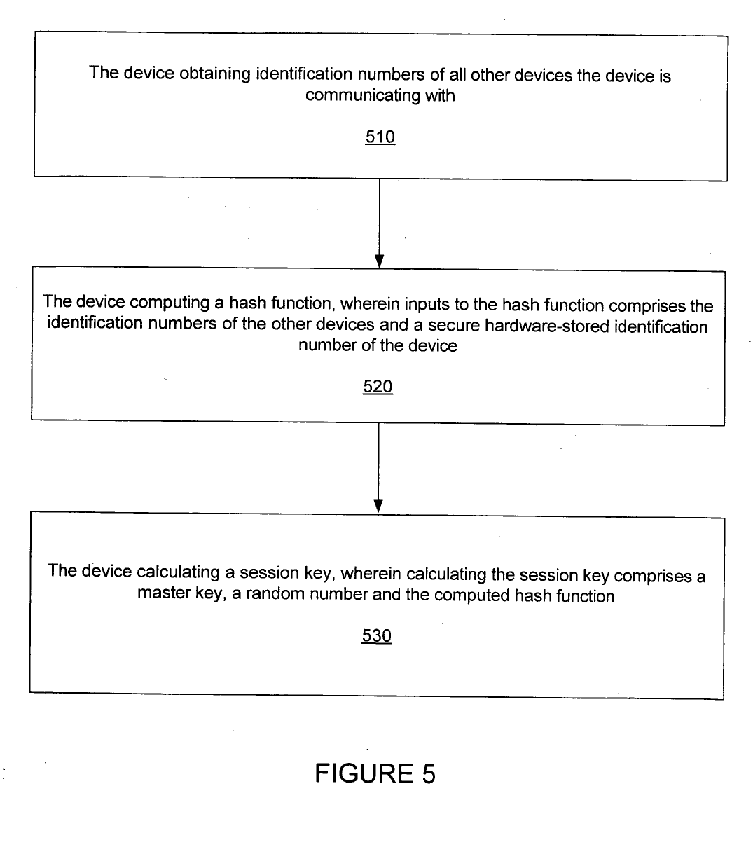

FIG. 5 shows a flow chart of step of an example of a of a network device maintaining secure communication. A first step 510 includes the device obtaining identification numbers of all other devices the device is communicating with. A second step 520 includes the device computing a hash function, wherein inputs to the hash function comprises the identification numbers of the other devices and a secure hardware-stored identification number of the device. A third step 530 includes the device calculating a session key, wherein calculating the session key comprises a master key, a random number and the computed hash function.

As described, the device obtains identification numbers of all other devices the device is in communication with every time at least one of all the other devices changes. If the network devices are commonly operated, each can include their own identification being maintained in hardware, and therefore, tamper-proof.

As described, the other network devices are re-authenticated with the addition of a new network device, or the removal (subtraction) of a previously authenticated network device.

As described, changes in the list of authenticated devices triggers re-calculating the session key because the computed hash function changes.

As described, the device encrypts and decrypts transmission data with the session key, thereby maintaining the secure communications.

As described, the network devices re-calculated the session key when the list of authenticated devices changes. Other embodiments include re-calculating the session key periodically dependent on time, or intermittently dependent on amount of data communicated by the network device.

An embodiment includes the secure hardware-stored identification number of the device being stored as a field programmable gate array serial number. Another embodiment includes embedding the secure self-identification into configuration information of the FPGA. Another embodiment includes embedding the secure self-identification into hardware logic in which the logic is optimized for obfuscating the self-identification as part of a bit stream of the FPGA;

Another embodiment includes the secure self-identification being burned into a write once-only, read-only EFuse (single time programming) circuit before the device is shipped. Another embodiment includes storing the secure self-identification in an embedded flash circuit with a single time programming EFuse.

Another embodiment further includes the device calculating multiple session keys, wherein each session key corresponding with a different sub-group of the all the other devices. The hash functions corresponding with each sub-group includes inputs of identification numbers of the device and the other devices that are included within each sub-group. For example, the device (for example, device 110 of FIG. 1) can form a first sub-group that includes the device 110, a second and a third device (such as, devices 120, 122). The device calculates a first session key that includes a hash function having the identification numbers of all the devices within the first sub-group (that is, identification numbers from devices 110, 120, 122). The device 110 can form a second sub-group with, for example, a fourth device (not shown). The device 110 then forms a second session key that includes a hash function having the identification numbers of all devices within the second sub-group (that is, the identification numbers of the device 110 and the fourth device).

FIG. 6 is a flow chart that includes steps of an example of method of securing a wireless network of wireless devices. A first step 610 includes each wireless device obtaining identification numbers of all other wireless devices the wireless device is communicating with. A second step 620 includes each wireless device computing a hash function, wherein inputs to the hash function comprises the identification numbers of the other devices and a secure hardware-stored identification number of the device. A third step 630 includes each wireless device calculating a session key, wherein calculating the session key comprises a master key, a random number and the computed hash function. A fourth step 640 includes each wireless device encrypting and decryption data communicated with the other wireless devices based on the session key computed by the wireless device.

Although specific embodiments have been described and illustrated, the embodiments are not to be limited to the specific forms or arrangements of parts so described and illustrated.

What is claimed:

1. A method of a network device maintaining secure communication, comprising:
the device obtaining identification numbers of all other devices the device is communicating with;
the device computing a hash function, wherein inputs to the hash function comprises the identification numbers of the other devices and a secure hardware-stored identification number of the device;
the device calculating a session key, wherein calculating the session key comprises a master key, a random number and the computed hash function.

2. The method of claim 1, further comprising:
the device re-obtaining identification numbers of all other devices the device is in communication with every time at least one of all the other devices changes.

3. The method of claim 1, wherein all other devices comprises devices within an authentication group.

4. The method of claim 3, wherein a number of devices within the authentication group is preset in hardware.

5. The method of claim 3, wherein the number of devices within the authentication group is preset in hardware comprises a smart card that includes the preset number.

6. The method of claim 5, further comprising storing ID's associated on the smart card.

7. The method of claim 2, further comprising:
the device re-authenticating all the other devices.

8. The method of claim 2, wherein at least one of all the other devices changes when a new device is added to all the other devices.

9. The method of claim 2, wherein at least one of all the other devices changes when an old device is subtracted from all the other devices.

10. The method of claim 2, further comprising re-calculating the session key when the computed hash function changes.

11. The method of claim 1, further comprising the device encrypting and decrypting transmission data with the session key.

12. The method of claim 1, wherein the secure hardware-stored identification number of the device is stored as a field programmable gate array serial number.

13. The method of claim 1, wherein the secure hardware-stored identification number of the device is embedding the secure self-identification into configuration information of an FPGA.

14. The method of claim 1, wherein the secure hardware-stored identification number of the device is being burned into a write once-only, read-only EFuse (single time programming) circuit before the device is shipped.

15. The method of claim 1, wherein the secure hardware-stored identification number of the device is embedded flash circuit with a single time programming EFuse.

16. The method of claim 1, further comprising the device calculating multiple session keys, each session key corresponding with a different sub-group of the all the other devices, and wherein inputs to hash functions corresponding with each sub-group comprise identification numbers of the device and the other devices that are included within each sub-group.

17. A method of securing a wireless network of wireless devices comprising:
each wireless device obtaining identification numbers of all other wireless devices the wireless device is communicating with;
each wireless device computing a hash function, wherein inputs to the hash function comprises the identification numbers of the other devices and a secure hardware-stored identification number of the device;
each wireless device calculating a session key, wherein calculating the session key comprises a master key, a random number and the computed hash function,
each wireless device encrypting and decryption data communicated with the other wireless devices based on the session key computed by the wireless device.

18. The method of claim 17, further comprising:
each wireless device maintaining a consistent ordering of inputs to the corresponding hash function, wherein the hash function of authenticated devices generate a consistent session key.

19. The method of claim 17, further comprising each device ordering operands of the hash function maintaining a consistent ordering amongst the devices of an authentication group.

20. The method of claim 17, further comprising:
each wireless device authenticating all the other wireless devices.

21. The method of claim 18, further comprising:
each wireless device re-calculating a session key when at least one authenticated wireless device of the wireless device changes.

22. The method of claim 17, further comprising each wireless device re-calculating the session key when the computed hash function changes.

23. The method of claim 17, further comprising periodically calculating a new random number.

24. The method of claim 17, wherein the secure hardware-stored identification number of each wireless device is stored as a field programmable gate array serial number.

25. A wireless device, comprising:
means for the device obtaining identification numbers of all other devices the device is communicating with;
means for the device computing a hash function, wherein inputs to the hash function comprises the identification numbers of the other devices and a secure hardware-stored identification number of the device;
means for the device calculating a session key, wherein calculating the session key comprises a master key, a random number and the computed hash function.
